(19) United States
(12) Patent Application Publication
(10) Pub. No.: US 2026/0259742 A1
(43) Pub. Date: Sep. 3, 2026

(54) Implementation Method and Apparatus for Starting Application

(71) Applicant: Feitian Technologies Co., Ltd., Beijing (CN)

(72) Inventors: Baohua MA, Beijing (CN); Zhou LU, Beijing (CN)

(21) Appl. No.: 18/878,903

(22) PCT Filed: Oct. 27, 2023
(86) PCT No.: PCT/CN2023/127074

§ 371 Date: Dec. 26, 2024

(30) Foreign Application Priority Data
Nov. 30, 2022 (CN) 202211514176.X

(51) Int. Cl. G06F 9/445; G06F 3/04817; G06F 3/04842; G06F 16/955; G06F 40/205

(52) U.S. Cl. CPC G06F 9/44505; G06F 3/04817; G06F 3/04842; G06F 16/9566; G06F 40/205

(57) ABSTRACT

An implementation method for starting an application, the method comprising: an Apple device establishing a connection with a card and starting communication; and the Apple device acquiring an NDEF file from the card and storing same, and parsing the NDEF file; acquiring a URL from the parsing result of the NDEF file, and determining whether the acquired URL matches a path in a stored associated file; if so, finding an application and an application icon according to an application ID in the associated file, displaying the application icon, and opening the application when receiving information indicating that a user triggers the application icon; otherwise, popping up a system notification box, displaying a browser icon, and when receiving information indicating that the user triggers the browser icon, jumping to a browser to download the application, thus ending the process. By means of the present invention, after an Apple device scans an NFC card, an application icon is displayed, such that the application starting efficiency is improved, and an abnormal system pop-up box is prevented, thereby improving the user experience and the operating efficiency of the device.

This application is a US application, which claims priority to PCT Application No. PCT/CN2023/127074, filed Oct. 27, 2023, which claims priority to CN Application No. 202211514176.X, filed Nov. 30, 2022, which are each incorporated herein by reference in their entireties.

### FIELD OF THE INVENTION

The present invention relates to a method for starting an application and apparatus therefor, and belongs to the field of application program technology.

### PRIOR ART

When an Apple device with iOS 13 or a higher version scans an NFC (Near Field Communication) card via an NFC function, a user needs to find an application and start it manually if there is no response from the Apple device, which makes the application starting efficiency low, resulting in a poor user experience. Furthermore, when the application is opened, every operation that is performed in the application requires the initialization of a session first, and then the session is closed after the operation ends. If the next operation is performed immediately after one operation ends, for example, a fingerprint deleting operation is performed immediately after a fingerprint verifying operation ends, at this time, there is a high probability that no popup boxes of the operating system occur, leading to a failure in the initialization of the session for the fingerprint deleting operation. The initialization of the session for the fingerprint deleting operation may still fail even if an interface is called to end the session for the fingerprint verifying operation. Therefore, how to solve the above-mentioned low application starting efficiency and abnormal popup boxes of the operating system is the technical problem currently urgent to be solved.

### SUMMARY OF THE INVENTION

An object of the present invention is to provide a method for starting an application and apparatus therefor, so as to display an application icon when an Apple device scans an NFC card, thereby improving the application starting efficiency, avoiding abnormal popup boxes of an operating system, and further improving the user experience and the work efficiency of the device.

According to the first aspect of the present invention, there is provided a method for starting an application, including:
Step S1: establishing, by an Apple device, a connection with a card, and starting communication;
Step S2: acquiring, by the Apple device, an NDEF file from the card, saving the NDEF file, and parsing the NDEF file;
Step S3: acquiring, by the Apple device, a URL from a parsing result of the NDEF file, determining whether the acquired URL matches a path in a saved associate file, if yes, executing
Step S5, otherwise, executing Step S4;
Step S4: popping up, by the Apple device, a system notification box, displaying a browser icon, jumping to a browser to download an application when receiving information that a user triggers the browser icon, and ending; and
Step S5: finding, by the Apple device, the application and an application icon according to an appID in the associate file, displaying the application icon, and opening the application when receiving information that a user triggers the application icon;
the method further includes:
Step A1: acquiring, by the Apple device, a configuration item of the application when detecting that an operating system downloads and installs the application;
Step A2: acquiring, by the Apple device, an associate domain name from the configuration item;
Step A3: accessing, by the Apple device, a corresponding server directory according to the associate domain name;
Step A4: searching for, by the Apple device, an associate file with a preset name in the server directory, executing Step A5 if the associate file is found, and reporting an error if the associate file is not found, wherein the associate file contains a preset path; and
Step A5: downloading, by the Apple device, the found associate file locally and saving the associate file.

According to the second aspect of the present invention, there is provided an apparatus for starting an application, including:
a connecting and communicating module configured to establish a connection with a card and start communication;
an acquiring and parsing module configured to acquire an NDEF file from the card, save the NDEF file, and parse the NDEF file;
an acquiring and determining module configured to acquire a URL from a parsing result of the NDEF file, and determine whether the acquired URL matches a path in a saved associate file;
a popup box jumping module configured to, when the acquiring and determining module determines that the result is no, pop up a system notification box, display a browser icon, jump to a browser to download an application when receiving information that a user triggers the browser icon, and end the process; and
a searching and opening module configured to, when the acquiring and determining module determines that the result is yes, find the application and an application icon according to an appID in the associate file, display the application icon, and open the application when receiving information that a user triggers the application icon.

The apparatus further includes:
a detecting and acquiring module configured to, when detecting that an operating system downloads and installs the application, acquire a configuration item of the application;
an acquiring and accessing module configured to acquire an associate domain name from the configuration item, and access a corresponding server directory according to the associate domain name;
a first searching module configured to search for an associate file with a preset name in the server directory, trigger a downloading and saving module if the associate file is found, and report an error if the associate file is not found, wherein the associate file contains a preset path; and
the downloading and saving module configured to download the found associate file locally and save the found associate file.

According to the third aspect of the present invention, there is provided an Apple device including at least one processor, a memory, and instructions stored on the memory and executable by the at least one processor, wherein the at least one processor executes the instructions to implement the aforementioned method for starting an application.

According to the fourth aspect of the present invention, there is provided a computer readable storage medium including a computer program which, when run on an Apple device, causes the Apple device to execute the aforementioned method for starting an application.

According to the fifth aspect of the present invention, there is provided a chip system including a chip coupled to a memory for executing a computer program stored in the memory to execute the aforementioned method for starting an application.

Compared with the prior art, the present invention enables an Apple device to display an application icon when scanning an NFC card to eliminate the process that a user searches for an application, thereby improving the application starting efficiency, avoiding abnormal popup boxes of the operating system, and further improving the user experience and the work efficiency of the device.

### BRIEF DESCRIPTION OF THE DRAWINGS

FIG. 1 is a flow chart of a method for starting an application according to Embodiment 1 of the present invention;

FIG. 2 is a flow chart of a method for starting an application according to Embodiment 2 of the present invention;

FIG. 3 is a flow chart of an implementation process of downloading an associate file according to Embodiment 2 of the present invention;

FIG. 4 is a flow chart of an implementation process that a user triggers an operation on a function interface of an application according to Embodiment 2 of the present invention; and

FIG. 5 is a block diagram of an apparatus for starting an application according to Embodiment 3 of the present invention.

### DETAILED DESCRIPTION OF PREFERRED EMBODIMENTS

The present invention provides a method for starting an application and apparatus therefor, and specific implementations of the present invention will be described in detail with reference to the accompanying drawings. Examples of the embodiments are illustrated in the accompanying drawings. The embodiments described below with reference to the accompanying drawings are exemplary, are only for explaining the present invention, and cannot be construed as limitations on the present invention.

It may be understood by those skilled in the art that, unless otherwise defined, all terms (including technical and scientific terms) used herein have the same meaning as commonly understood by those skilled in the art. It may be further understood that terms, such as those defined in general dictionaries, should be interpreted as having the meanings that are consistent with their meanings in the context of the prior art and will not be interpreted in an idealized or overly formal sense unless specifically defined as herein.

In order to further clarify the objects, technical solutions and advantages of the present invention, the implementations of the present invention will be further described in detail below with reference to the accompanying drawings.

In the embodiments of the present invention, the card supports the ISO 14443 Type A protocol.

### Embodiment 1

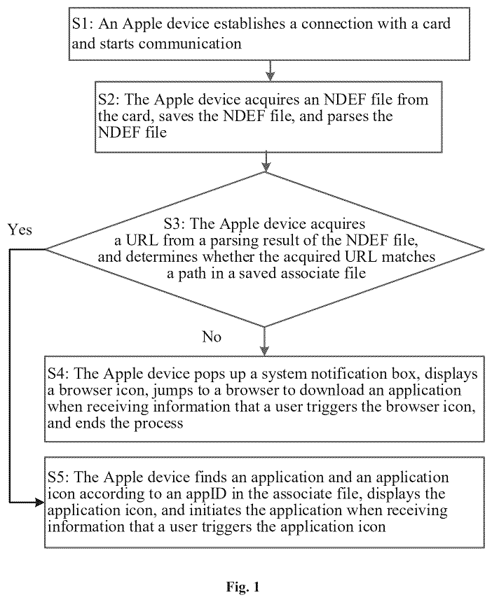

Embodiment 1 of the present invention provides a method for starting an application, as shown in FIG. 1, including the following steps.
Step S1: an Apple device establishes a connection with a card and starts communication.

Specifically, in this embodiment, Step S1 includes:
Step S1-1: the Apple device sends a card searching instruction to surrounding cards when detecting that NFC is enabled;
Step S1-2: the Apple device receives card searching response data returned by/from the cards, determines whether corresponding cards support collision prevention according to the card searching response data, if yes, executes Step S1-3, otherwise, reports an error;
Step S1-3: the Apple device sends a device information acquiring instruction to all cards in a field, and receives card information returned by each card;
Step S1-4: the Apple device acquires UIDs of the corresponding cards from the received card information, and sends an in-field designated card searching instruction to the corresponding cards according to the UIDs in turn;
Step S1-5: the Apple device sends an activation instruction to a corresponding card after receiving an in-field designated card searching response returned by the card;
Step S1-6: the Apple device sends an application selection instruction to the card after receiving activation success information returned by the card;
Step S1-7: the Apple device sends a source file acquiring instruction to the card based on an application selection response after receiving the application selection response returned by the card, and receives a source file acquiring response returned by the card.
Step S2: the Apple device acquires an NDEF file from the card, saves the NDEF file, and parses the NDEF file.

Specifically, Step S2 of Embodiment 1 includes:
Step S2-1: the Apple device sends an NDEF file acquiring instruction to the card;
Step S2-2: the Apple device receives an NDEF file returned by the card, saves the NDEF file, parses the NDEF file, determines whether the parsing succeeds, if yes, executes Step S3, otherwise, reports an error;
Step S3: the Apple device acquires a URL from a parsing result of the NDEF file, determines whether the acquired URL matches a path in a saved associate file, if yes, executes Step S5, otherwise, executes Step S4.

Specifically, in Embodiment 1, the determining whether the acquired URL matches the path in the saved associate file includes:
Step E1: the Apple device splices an associate domain name corresponding to the associate file with a first path in the associate file to obtain a splicing result;
Step E2: the Apple device matches the acquired URL with the splicing result, executes Step S5 if the URL is contained in the splicing result, otherwise, executes Step E3;
Step E3: the Apple device determines whether paths in the associate file are all processed, if yes, executes Step S4, otherwise, executes Step E4;
Step E4: the Apple device splices the associate domain name corresponding to the associate file with a next path in the associate file to obtain a splicing result, and returns to Step E2.
Step S4: the Apple device pops up a system notification box, displays a browser icon, jumps to a browser to download an application when receiving information that a user triggers the browser icon, and ends the process.
Step S5: the Apple device finds an application and an application icon according to an appID in the associate file, displays the application icon, and opens the application when receiving information that a user triggers the application icon.

Specifically, in this embodiment, the Apple device finding the application and the application icon according to the appID in the associate file includes: the Apple device parses the appID in the associate file to obtain a teamID and a bundle ID, and finds the application and the application icon according to the teamID and the bundle ID.

The method of this embodiment further includes:
Step A1: the Apple device acquires a configuration item of the application when detecting that the operating system downloads and installs an application;
Step A2: the Apple device acquires an associate domain name from the configuration item;
Step A3: the Apple device accesses a corresponding server directory according to the associate domain name; and
Step A4: the Apple device searches for an associate file with a preset name in the server directory, executes Step A5 if the associate file is found, and reports an error if the associate file is not found.

In Embodiment 1, the associate file contains a preset path.

Specifically, Step A4 of Embodiment 1 includes:
Step A4-1: the Apple device searches for the associate file with the preset name under a root directory in the server directory, executes Step A5 if the associate file is found, and executes Step A4-2 if the associate file is not found; and
Step A4-2: the Apple device searches for the associate file with the preset name under a preset directory in the server directory, executes Step A5 if the associate file is found, and reports an error if the associate file is not found.
Step A5: the Apple device downloads the found associate file locally and saves the associate file.

Preferably, in this embodiment, after Step S5, the method includes:
Step S6: the application acquires the NDEF file using a system function, parses the NDEF file, determines whether an activity type is a preset type according to NDEF data in a parsing result, if yes, executes Step S7, otherwise, reports an error; and
Step S7: the application jumps to a corresponding application interface according to a URL in the parsing result.

Preferably, after Step S7, the method includes:
Step T1: the application prepares to create a session while recording current time when detecting triggering information from a user on the application interface;
Step T2: the application checks a value of first time, executes Step T4 if the value is an initial value, otherwise, executes Step T3;
the initial value of the first time in this embodiment is 0;
Step T3: the application determines whether a time difference between the current time and the first time is greater than a preset value, if yes, executes Step T4, otherwise, executes Step T4 after a difference value between the preset value and a value of the current time; and
Step T4: the application creates a session and sets reminder information in a popup box of the operating system, initializes the session and performs a corresponding operation; when the corresponding operation is completed, the application ends the session and the popup box of the operating system disappears; the application records time at which the session ends, updates the first time with the time at which the session ends, and returns to Step T1.

The method provided in Embodiment 1 enables the Apple device to display the application icon when scanning the NFC card to eliminate the process that the user searches for the application, thus improving the application starting efficiency. Furthermore, when the user operates on the application interface, the operating system can automatically prompt a popup box, ensuring successful initialization of a session for each operation, and subsequently improving the user experience and the work efficiency of the device. Meanwhile, the method solves the problem related to the abnormal popup boxes of the operating system.

### Embodiment 2

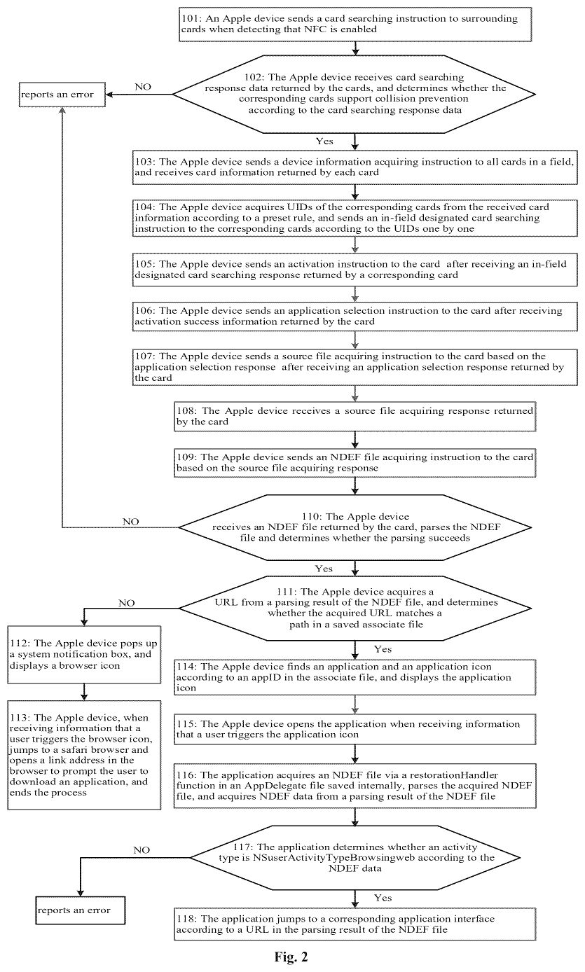

Embodiment 2 of the present invention provides a method for starting an application, as shown in FIG. 2, including the following steps.
Step 101: an Apple device sends a card searching instruction to surrounding cards when detecting that NFC is enabled;
for example, the card searching instruction in this embodiment is: 0x26.
Step 102: the Apple device receives card searching response data returned by the cards, and determines whether corresponding cards support collision prevention according to the card searching response data, if yes, executes Step 103, otherwise, reports an error.

Specifically, in Embodiment 2, the determining whether the cards support collision prevention according to the card searching response data includes: it is determined whether the highest 5 bits in the card searching response data contain only a single 1; if yes, the cards support collision prevention, otherwise, the cards do not support collision prevention; the response data from right to left is sequenced from high bits to low bits.

For example, in this step, card searching response data returned by a card is: 0x0200 (corresponding binary is 0000 0000 0000 0010), and the highest 5 bits of the card searching response data contain and only contain a single 1, so that it is determined that the card supports collision prevention.
Step 103: the Apple device sends a device information acquiring instruction to all cards in a field, and receives card information returned by each card.

For example, in this step, the device information acquiring instruction is: 0x9320, and the returned card information is: 0x3FB26FBB59.
Step 104: the Apple device acquires UIDs (Unique identifier) of the corresponding cards from the received card information according to a preset rule, and sends an in-field designated card searching instruction to the corresponding cards according to the UIDs one by one.

Specifically, in Embodiment 2, the Apple device acquiring the UIDs of the corresponding cards from the received card information according to the preset rule includes: the Apple device acquires, from the received card information, the first 4 bytes of data as the UID, and the last 1 byte is a check bit.

For example, the acquired UID of the corresponding card is: 0x3FB26FBB, and the in-field designated card searching instruction is: 0x93703FB26FBB595361.
Step 105: the Apple device sends an activation instruction to a corresponding card after receiving an in-field designated card searching response returned by the card.

In Embodiment 2, the Apple device can only receive the in-field designated card searching response returned by one card.

For example, in this step, the in-field designated card searching response is: 0x20FC70, and the activation instruction is: 0xE0 80 31 73.
Step 106: the Apple device sends an application selection instruction to the card after receiving activation success information returned by the card.

For example, in this step, the activation success information is: 0x14 78 80 70 02 46 54 2D 4A 43 4F 53 20 42 69 6F 43 41 52 44 F8 28, and the application selection instruction is: 0x02 00 A4 04 00 07 D2 76 00 00 85 01 01 00 35 C0.

Specifically, in Embodiment 2, the card, after receiving the application selection instruction, determines whether a card application corresponding to the application selection instruction is an executable application, if yes, the card returns an application selection response that the application is executable to the Apple device, otherwise, the card returns an application selection response that the application is not executable to the Apple device.
Step 107: the Apple device sends a source file acquiring instruction to the card based on an application selection response after receiving the application selection response returned by the card.

Specifically, in Embodiment 2, the card, after receiving the source file acquiring instruction, determines whether a corresponding source file is an executable file based on the source file acquiring instruction, if yes, the card returns a source file acquiring response that the source file is executable to the Apple device, otherwise, the card returns a source file acquiring response that the source file is not executable to the Apple device.

For example, in this step, the application selection response is: 0x02 90 00 F1 09, and the source file acquiring instruction is: 0x03 00 A4 00 OC 02 E1 03 D2 AF.
Step 108: the Apple device receives the source file acquiring response returned by the card.

For example, the source file acquiring response in this step is: 0x03 90 00 2D 53.
Step 109: the Apple device sends an NDEF (NFC data exchange format) file acquiring instruction to the card based on the source file acquiring response.
For example, the NDEF file acquiring instruction in this step is: 0x02 00 BO 00 00 OF 8E A6.
Step 110: the Apple device receives an NDEF file returned by the card, parses the NDEF file, determines whether the parsing succeeds, if yes, executes Step 111, otherwise, reports an error.

For example, the NDEF file in this step is: 0x02 00 OF 20 00 80 00 80 04 06 E1 04 01 00 00 00 90 00 88 D9.

Preferably, in Embodiment 2, before Step 110, the method further includes: the card parses the received NDEF file acquiring instruction to obtain a link address, acquires the corresponding NDEF file according to the link address, and returns the acquired NDEF file to the Apple device.
Step 111: the Apple device acquires a URL (Uniform Resource Locator) from a parsing result of the NDEF file, determines whether the acquired URL matches a path in a saved associate file, if yes, executes Step 114, otherwise, executes Step 112.

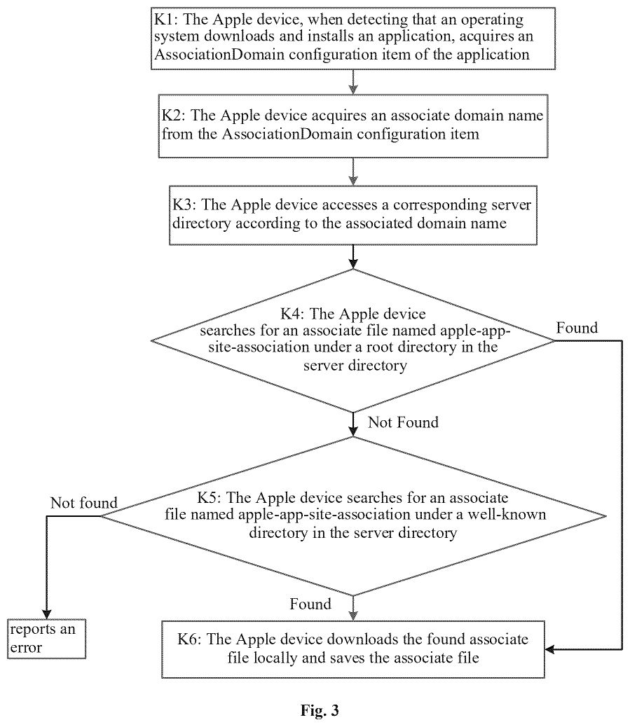

Preferably, in Embodiment 2, before Step 111, the method further includes: the Apple device downloads the associate file and saves the associate file, as shown in FIG. 3, which includes the following steps.
Step K1: the Apple device, when detecting that the operating system downloads and installs an application, acquires an AssociationDomain configuration item of the application.
Step K2: the Apple device acquires an associate domain name from the AssociationDomain configuration item;
for example, in this step, the associate domain name acquired by the Apple device from the AssociationDomain configuration item is: applinks:www.ftsafe.com.
Step K3: the Apple device accesses a corresponding server directory according to the associate domain name.

Preferably, in Embodiment 2, the server directory in this step includes a root directory and a well-known directory.
Step K4: the Apple device searches for an associate file named apple-app-site-association under a root directory in the server directory, executes Step K6 if the associate file is found, and executes Step K5 if the associate file is not found.
Step K5: the Apple device searches for an associate file named apple-app-site-association under the well-known directory in the server directory, executes Step K6 if the associate file is found, and reports an error if the associate file is not found.
Step K6: the Apple device downloads the found associate file locally and saves the associate file.

In Embodiment 2, the associate file contains a preset path;
for example, the associate file in this embodiment is: apple-app-site-association

```
{ “applinks”:{
    “apps”:[ ],
    “details”:[
{
  “appID”:”S47T4UESP3.com.ftsafe.com”
  “paths”:[“/question/*”, “/safe/*”, “/p/*”];
}
}
```

where, an appID includes a team/D and a bundle ID, the teamID is S47T4UESP3 and the bundle ID is com.ftsafe.com;
the URL acquired from the parsing result is: www.ftsafe.com/question/testfrintcard.

In Embodiment 2, the determining whether the acquired URL matches the path in the saved associate file is specifically as follows.
Step E1: the Apple device splices an associate domain name corresponding to the associate file with a first path in the associate file to obtain a splicing result;
for example, the splicing result in this step is: www.ftsafe.com/questoin/*.
Step E2: the Apple device matches the URL with the splicing result, if the URL is contained in the splicing result, executes Step 114, otherwise, executes Step E3.
Step E3: the Apple device determines whether paths in the associate file are all processed, if yes, executes Step 112, otherwise executes Step E4; and
Step E4: the Apple device splices the associate domain name with a next path in the associate file to obtain a splicing result, and returns to Step E2.
For example, the splicing result in this step is: www.ftsafe.com/safe/*.
Step 112: the Apple device pops up a system notification box, and displays a browser icon.
Step 113: the Apple device, when receiving information that a user triggers the browser icon, jumps to a safari browser and opens a link address in the browser to prompt the user to download an application, and ends a process of the method.
Step 114: the Apple device finds an application and an application icon according to an appID in the associate file, and displays the application icon.

Specifically, in this embodiment, Step 114 includes: the Apple device parses the appID (Application Identifier) in the associate file to obtain a teamID (Team Identifier) and a bundle ID (Bundle Identifier), finds the application and the application icon according to the teamID and the bundle ID, and displays the application icon.
Step 115: the Apple device opens the application when receiving information that a user triggers the application icon.

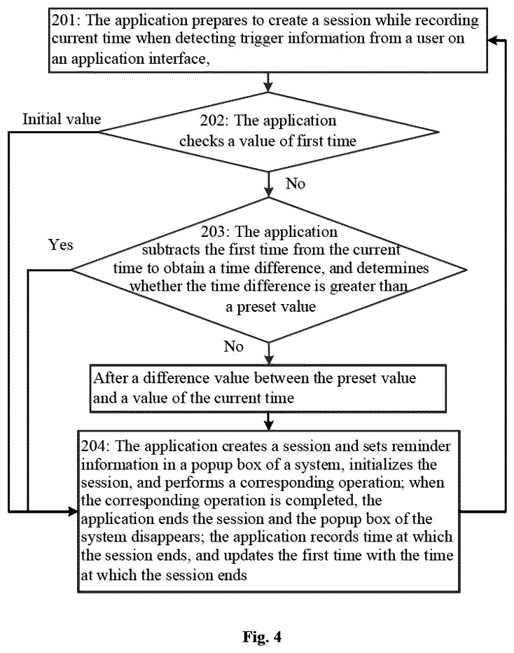

In Embodiment 2, after the application is opened, the user can trigger corresponding operations on different function interfaces of the application.
Step 116: the application acquires an NDEF file via a restorationHandler function in an AppDelegate (application delegate) file saved internally, parses the acquired NDEF file, and acquires NDEF data from a parsing result of the NDEF file.
Step 117: the application determines whether an activity type is NSuserActivityTypeBrowsingweb according to the NDEF data, if yes, executes Step 118, otherwise, reports an error; and
Step 118: the application jumps to a corresponding application interface according to a URL in the parsing result of the NDEF file.
In Embodiment 2, different application interfaces correspond to different URLs;
for example, in this embodiment, a fingerprint application interface includes a fingerprint enrolling operation, a fingerprint verifying operation, and a fingerprint deleting operation.
In Embodiment 2, a user can trigger different operations on the application interface, and the specific implementation process, as shown in FIG. 4, includes the following steps.
Step 201: the application prepares to create a session while recording current time when detecting triggering information from a user on the application interface;
preferably, the triggering information from the user on the application interface may be the same or different each time, e.g., the first triggering information is triggering information for verifying a fingerprint, and the next triggering information is triggering information for deleting a fingerprint.
Step 202: the application checks a value of first time, executes Step 204 if the value is an initial value, otherwise, executes Step 203.

Specifically, the initial value of the first time in this embodiment is 0.
Step 203: the application subtracts the first time from the current time to obtain a time difference, and determines whether the time difference is greater than a preset value, if yes, executes Step 204, otherwise, executes Step 204 after a difference value between the preset value and a value of the current time.

Preferably, the preset value in this embodiment is 1700.
Step 204: the application creates a session and sets reminder information in a popup box of the operating system, initializes the session and performs a corresponding operation; when the corresponding operation is completed, the application ends the session and the popup box of the operating system disappears; the application records time at which the session ends, updates the first time with the time at which the session ends, and returns to Step 201.

According to the present invention, the Apple device is enabled to display the application icon after reading the NFC card, eliminating the process that the user searches for the application, thus improving the application starting efficiency, and optimizing the user experience. Furthermore, the operating system can automatically prompt a popup box for each operation after the application is started, thereby ensuring successful initialization of a session for each operation, simplifying the work flow of the device, improving the work efficiency of the device, and solving the problem of abnormal popup boxes of the operating system.

### Embodiment 3

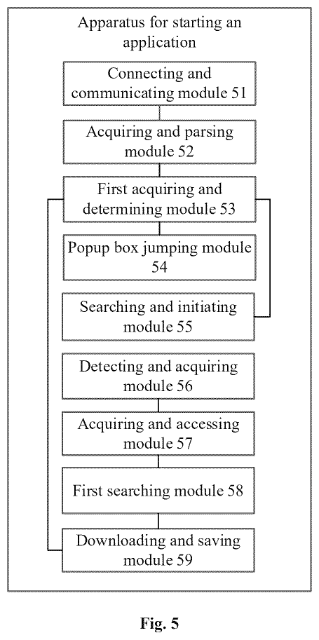

Embodiment 3 of the present invention provides an apparatus for starting an application, as shown in FIG. 5, including:
a connecting and communicating module 51 configured to establish a connection with a card and start communication;
an acquiring and parsing module 52 configured to acquire an NDEF file from the card, save the NDEF file, and parse the NDEF file;
a first acquiring and determining module 53 configured to acquire a URL from a parsing result of the NDEF file, and determine whether the acquired URL matches a path in a saved associate file;
a popup box jumping module 54 configured to, when the acquiring and determining module 53 determines that the result is no, pop up a system notification box, display a browser icon, jump to a browser to download an application when receiving information that a user triggers the browser icon, and end the process; and
a searching and opening module 55 configured to, when the acquiring and determining module 53 determines that the result is yes, find an application and an application icon according to an appID in the associate file, display the application icon, and open the application when receiving information that a user triggers the application icon.

The apparatus of this embodiment further includes:
a detecting and acquiring module 56 configured to, when detecting that an operating system downloads and installs the application, acquire a configuration item of the application;
an acquiring and accessing module 57 configured to acquire an associate domain name from the configuration item, and access a corresponding server directory according to the associate domain name;
a first searching module 58 configured to search for an associate file with a preset name in the server directory, trigger a downloading and saving module 59 if the associate file is found, and report an error if the associate file is not found, wherein the associate file contains a preset path; and
the downloading and saving module 59 configured to download the found associate file locally and save the found associate file.

Further, the first searching module 58 in this embodiment includes:
a first searching unit configured to search for the associate file with the preset name under a root directory in the server directory, trigger the downloading and saving module 59 if the associate file is found, and trigger a second searching unit if the associate file is not found; and
the second searching unit configured to search for the associate file with the preset name under a preset directory in the server directory, trigger the downloading and saving module 59 if the associate file is found, and report an error if the associate file is not found.

Further, the connecting and communicating module 51 in this embodiment includes:
a detecting and sending unit configured to send a card searching instruction to surrounding cards when detecting that NFC is enabled;
a receiving and determining unit configured to receive card searching response data returned by the cards, determines whether corresponding cards support collision prevention according to the card searching response data, if yes, trigger a first sending and receiving unit, otherwise, report an error;
the first sending and receiving unit configured to send a device information acquiring instruction to all cards in a field, and receive card information returned by each card;
an acquiring and sending unit configured to acquire UIDs of the corresponding cards from the received card information, send an in-field designated card searching instruction to the corresponding cards according to the UIDs one by one;
a second sending and receiving unit configured to send an activation instruction to a card after receiving an in-field designated card searching response returned by the card;
a third sending and receiving unit configured to send an application selection instruction to the card after receiving activation success information returned by the card; and
a fourth sending and receiving unit configured to send a source file acquiring instruction to the card based on an application selection response after receiving the application selection response returned by the card, and receive a source file acquiring response returned by the card.

Further, the acquiring and parsing module 52 in this embodiment is specifically configured to send an NDEF file acquiring instruction to the card, receive an NDEF file returned by the card, save the NDEF file, parse the NDEF file, determine whether the parsing succeeds, if yes, trigger the acquiring and determining module 53, otherwise, report an error.

Preferably, the apparatus of this embodiment further includes:
a second acquiring and determining module configured to acquire an NDEF file using a system function, parse the NDEF file, determine whether an activity type is a preset type according to NDEF data in a parsing result, if yes, trigger a parsing and jumping module, otherwise, report an error; and
the parsing and jumping module configured to jump to a corresponding application interface according to a URL in the parsing result.

Preferably, the apparatus of this embodiment further includes:
a detecting and recording module configured to, when detecting triggering information from a user on the application interface, create a session while recording current time;
a first checking module configured to check a value of first time, trigger a creating and updating module if the value is an initial value, otherwise, trigger a determining and waiting module;
in which the initial value of the first time in this embodiment is 0;
the determining and waiting module configured to determine whether a time difference between the current time and the first time is greater than a preset value, if yes, trigger the creating and updating module, otherwise, trigger the creating and updating module after a difference value between the preset value and a value of the current time; and
the creating and updating module configured to create a session and set reminder information in a popup box of the operating system, initialize the session, perform a corresponding operation; when the corresponding operation is completed, the creating and updating module ends the session and the popup box of the operating system disappears; the creating and updating module configured to record time at which the session ends, update the first time with the time at which the session ends, and trigger the detecting and recording module.

Further, the first acquiring and determining module 53 in this embodiment includes:
an acquiring and splicing unit configured to acquire a URL from the parsing result of the NDEF file, splice an associate domain name corresponding to the associate file with a first path in the associate file to obtain a splicing result;
a first matching unit configured to match the acquired URL with the splicing result, if the URL is contained in the splicing result, trigger the searching and opening module 55, otherwise, trigger a first determining unit;
the first determining unit configured to determine whether paths in the associate file are all processed, if yes, trigger the popup box jumping module 54, otherwise, trigger a first splicing unit; and
the first splicing unit configured to splice the associate domain name corresponding to the associate file with a next path in the associate file to obtain a splicing result, and trigger the first matching unit.

Further, the searching and opening module 55 in this embodiment is specifically configured to parse, when the acquiring and determining module 53 determines that the result is yes, the appID in the associate file to obtain a teamID and a bundle ID, find the application and the application icon according to the teamID and the bundle ID, display the application icon, and open the application when receiving the information that the user triggers the application icon.

Preferably, the present invention also provides an Apple device, including at least one processor, a memory, and instructions stored on the memory and executable by the at least one processor, wherein the at least one processor executes the instructions to implement the method for starting an application in the above embodiments. When the Apple device employs a chip system, the chip system may be composed of a chip, or may include a chip and other discrete devices, and the present invention is not particularly limited thereto. The chip is coupled to the memory for executing a computer program stored in the memory to perform the method for starting an application disclosed in the above embodiments.

The above embodiments may be implemented, in whole or in part, by software, hardware, firmware, or any combination thereof. When implemented using a software program, it may be implemented in whole or in part in the form of a computer program product. The computer program product includes one or more computer programs. When the computer program is loaded and executed on the Apple device, the processes or functions of the present invention are produced in whole or in part. The computer program may be stored in a computer readable storage medium, or transmitted from one computer readable storage medium to another computer readable storage medium, for example, the computer instructions may be transmitted from one base station, Apple device, server, or data center to another base station, Apple device, server, or data center in a wired (e.g., coaxial cable, optical fiber, digital subscriber line (DSL)) manner or a wireless (e.g., infrared, radio, microwave, etc.) manner. The computer readable storage medium may be any available media that can be accessed by an Apple device or data storage devices including one or more servers, data centers, or the like that may be integrated with the media. The available media may be magnetic media (e.g., floppy disk, hard disk, magnetic tape), optical media (e.g., DVD), or semiconductor media [e.g., solid state disk (SSD)], etc. In the present invention, the Apple device may include the aforementioned apparatus.

Although the present invention has been described herein in conjunction with various embodiments, those skilled in the art may understand and implement other variations to the disclosed embodiments when practicing the claimed invention by reviewing the drawings, the disclosure, and the appended claims. In the claims, the word “comprising” does not exclude other elements or steps and the word “a” or “an” does not exclude the possibility of plurality. A single processor or other units may implement multiple functions recited in the claims. The fact that certain measures are recited in mutually different dependent claims does not indicate that the combination of these measures cannot yield good effects.

Although the present invention has been described in conjunction with specific features and embodiments thereof, it will be apparent that various modifications and combinations can be made thereto without departing from the spirit and scope of the present invention. Accordingly, the description and drawings are merely exemplary illustrations of the present invention as defined by the appended claims, and are considered to cover any and all modifications, variations, combinations or equivalents that are within the scope of the present invention. It will be apparent to those skilled in the art that various modifications and variations can be made to the present invention without departing from the spirit and scope of the present invention. Thus, the present invention is intended to cover the modifications and variations of the present invention provided they fall within the scope of protection of the appended claims and their equivalents.

1. A method for starting an application, wherein the method comprises the following steps:
S1) establishing, by an Apple device, a connection with a card, and starting communication;
S2) acquiring, by the Apple device, an NDEF file from the card, saving the NDEF file, and parsing the NDEF file;
S3) acquiring, by the Apple device, a URL from a parsing result of the NDEF file, determining whether the URL matches a path in a saved associate file, if yes, executing step S5, otherwise, executing step S4;
S4) popping up, by the Apple device, a system notification box, displaying a browser icon, jumping to a browser to download an application when receiving information that a user triggers the browser icon, and ending the method; and
S5) finding, by the Apple device, the application and an application icon according to an appID in the associate file, displaying the application icon, and opening the application when receiving information that a user triggers the application icon;
the method further comprises the following steps:
A1) acquiring, by the Apple device, a configuration item(s) of the application when detecting that an operating system downloads and installs the application;
A2) acquiring, by the Apple device, an associate domain name from the configuration item;
A3) accessing, by the Apple device, a corresponding server directory according to the associate domain name;
A4) searching for, by the Apple device, the associate file with a preset name in the server directory, executing Step A5 if the associate file is found, and reporting an error if the associate file is not found, in which the associate file contains a preset path; and
A5) finding, by the Apple device, the associate file; downloading locally the associate file found; and saving the associate file.

2. The method according to claim 1, wherein Step A4 comprises the following steps:
A4-1) searching for, by the Apple device, the associate file with the preset name under a root directory in the server directory, executing Step A5 if the associate file is found, and executing Step A4-2 if the associate file is not found; and
A4-2) searching for, by the Apple device, the associate file with the preset name under a preset directory in the server directory, executing Step A5 if the associate file is found, and reporting an error if the associate file is not found.

3. The method according to claim 1, wherein step S1 comprises the following steps:
S1-1) sending, by the Apple device, a card searching instruction to surrounding cards when detecting that NFC is enabled;
S1-2) receiving, by the Apple device, card searching response data returned by/from the cards, determining whether corresponding cards support collision prevention according to the card searching response data, if yes, executing step S1-3, otherwise, reporting an error;
S1-3) sending, by the Apple device, a device information acquiring instruction to all cards in a field, and receiving card information returned by each card;
S1-4) acquiring, by the Apple device, UIDs of the corresponding cards from the card information received, and sending an in-field designated card searching instruction to the corresponding cards according to the UIDs one by one;
S1-5) sending, by the Apple device, an activation instruction to the card after receiving an in-field designated card searching response returned by the card;
S1-6) sending, by the Apple device, an application selection instruction to the card after receiving activation success information returned by the card; and
S1-7) sending, by the Apple device, a source file acquiring instruction to the card based on the application selection response after receiving the application selection response returned by the card, and receiving a source file acquiring response returned by the card.

4. The method according to claim 1, wherein step S2 comprises the following steps:
S2-1) sending, by the Apple device, an NDEF file acquiring instruction to the card; and
S2-2) receiving, by the Apple device, an NDEF file returned by the card, saving the NDEF file, parsing the NDEF file, and determining whether the parsing succeeds, if yes, executing step S3, otherwise, reporting an error.

5. The method according to claim 1, wherein after step S5, the method further comprises the following steps:
S6) acquiring, by the application, the NDEF file using a system function, parsing the NDEF file acquired, determining whether an activity type is a preset type according to NDEF data in a parsing result, if yes, executing step S7, otherwise, reporting an error; and
S7) jumping to, by the application, a corresponding application interface according to a URL in the parsing result.

6. The method according to claim 5, wherein after step S7, the method further comprises the following steps:
T1) preparing, by the application, to create a session while recording current time when detecting triggering information from a user on the application interface;
T2) checking, by the application, a value of first time, if the value is an initial value, executing step T4, otherwise, executing step T3, in which the initial value of the first time is 0;
T3) determining, by the application, whether a time difference between current time and the first time is greater than a preset value, if yes, executing step T4, otherwise, executing step T4 after a difference value between the preset value and the current time; and
T4) creating, by the application, the session, setting reminder information in a popup box of the operating system, initializing the session, and performing a corresponding operation; when the corresponding operation is completed, ending the session and making the popup box of the operating system disappear; and recording time at which the session ends, updating the first time with the time at which the session ends, then returning to step T1.

7. The method according to claim 1, wherein for determining whether the URL acquired matches the path in the saved associate file comprises the following steps:
E1) splicing, by the Apple device, the associate domain name corresponding to the associate file with a first path in the associate file to obtain a splicing result;
E2) matching, by the Apple device, the URL acquired with the splicing result, if the URL is contained in the splicing result, executing step S5, otherwise, executing Step E3;
E3) determining, by the Apple device, whether paths in the associate file are all processed, if yes, executing step S4, otherwise, executing Step E4; and
E4) splicing, by the Apple device, the associate domain name corresponding to the associate file with a next path in the associate file to obtain a splicing result, then returning to Step E2.

8. The method according to claim 1, wherein for finding, by the Apple device, the application and the application icon according to the appID in the associate file, the method comprises: parsing, by the Apple device, the appID in the associate file to obtain a teamID and a bundle ID, and finding the application and the application icon according to the teamID and the bundle ID.

9. An apparatus for starting an application, wherein the apparatus comprises:
a module for connecting and communicating, configured to establish a connection with a card and start communication;
a module for acquiring and parsing, configured to acquire an NDEF file from the card, save the NDEF file, and parse the NDEF file;
a module for acquiring and determining, configured to acquire a URL from a parsing result of the NDEF file, and determine whether the URL acquired matches a path in a saved associate file;
a module for performing popup box jumping, configured to, when the module for acquiring and determining determines that result is no, pop up a system notification box, display a browser icon, jump to a browser to download the application when receiving information that a user triggers the browser icon, then stopping the apparatus; and
a module for searching and opening, configured to, when the module for acquiring and determining determines that the result is yes, find the application and an application icon according to an appID in the associate file, display the application icon, and open the application when receiving information that a user triggers the application icon;
the apparatus further comprises:
a module for detecting and acquiring, configured to, when detecting that an operating system downloads and installs the application, acquire a configuration item of the application;
a module for acquiring and accessing, configured to acquire an associate domain name from the configuration item, and access a corresponding server directory according to the associate domain name;
a first module for searching, configured to search for an associate file with a preset name in the server directory, trigger a module for downloading and saving if the associate file is found, and report an error if the associate file is not found, in which the associate file contains a preset path; and
the module for downloading and saving, configured to find the associate file, download locally the associate file found, and save the associate file found.

10. An Apple device, a computer readable storage medium, or a chip system, wherein the Apple device comprises at least one processor, a memory, and instructions stored on the memory and executable by the at least one processor, the at least one processor executing the instructions to implement the method according to claim 1.

11. The Apple device, the computer readable storage medium, or the chip system according to claim 10, wherein the computer readable storage medium comprises a computer program which, when running on an Apple device, causes the Apple device to perform the method according to claim 1.

12. The Apple device, the computer readable storage medium, or the chip system according to claim 10, wherein the chip system comprises a chip coupled to a memory for executing a computer program stored in the memory to perform the method according to claim 1.
